(19) United States
(12) Patent Application Publication
(10) Pub. No.: US 2002/0010815 A1
(43) Pub. Date: Jan. 24, 2002

(54) Data transfer method and data recording apparatus

(76) Inventors: Yutaka Arakawa, Hamura-shi (JP); Masayuki Fukuzaki, Koga-shi (JP)

Correspondence Address: Finnegan, Henderson, Farabow,, Garrett & Dunner, L.L.P., 1300 I Street, N. W., Washington, DC, 20005-3315, US

(21) Appl. No.: 09/805,171

(22) Filed: Mar. 14, 2001

(30) Foreign Application Priority Data
Mar. 27, 2000 (JP) 2000-087555

(51) Int. Cl. G06F 13/14; G06F 13/28; G11B 5/02

(52) U.S. Cl. 710/33; 360/55

(57) ABSTRACT

A data recording apparatus includes a serial interface which is capable of carrying out data transfer in a page mode for transferring, based on a return address and a return data length specified by a host as a data transfer destination, page data in units of page corresponding to the specified return data length for the specified return address, a page table buffer which stores a page table address defining the return address and return data length for each page data acquired from the host, and a central processing unit which successively supplies to the serial interface, page data in units of page in accordance with the page table address stored in the page table buffer, without interrupting the data transfer in the page mode.

### CROSS-REFERENCE TO RELATED APPLICATIONS

This application is based upon and claims the benefit of priority from the prior Japanese patent Application No. 2000-087555, filed, Mar. 27, 2000, the entire contents of which are incorporated herein by reference.

### BACKGROUND OF THE INVENTION

The present invention relates to a data transfer method and a data recording apparatus, which conform to serial interface standards capable of transferring data in a page mode, for example, an IEEE 1394 interface.

Conventionally, various techniques for continuously transmitting data between apparatuses have been presented. For example, Japanese Patent No. 2,503,299 relates to a technique for continuously transferring data of a desired number of pages with desired capacities from a peripheral (a content retrieval apparatus) to a main apparatus (a channel apparatus) without interrupting an internal process of the peripheral. More specifically, the patent specification discloses an information processing system for executing data transfer by a channel program between the channel apparatus of the main apparatus and the peripheral connected to the channel apparatus via an input/output interface. In the system, control information of a control command in a command chain of a channel program designates the capacity of a data block to be transmitted by subsequent data transfer commands and the number of data transfer commands. The information processing system is continuously operated until the data transfer of the capacity corresponding to the designated number of data transfer commands is completed, without interrupting the operation of the peripheral at every data transfer command.

In recent years, various devices (magnetic disk drives) in conformity with IEEE 1394 interface standards have come on the market.

A page mode is one of the transfer systems defined by the IEEE 1394 interface standards. It means a mode for transferring data between a host and a device page by page based on the contents stored in a page table provided on the host side.

The page table includes a plurality of return memory addresses and return data lengths in connection with data to be transferred on a page-by-page basis. The device executes, page by page, data transfer corresponding to the respective addresses and data lengths indicated on the page table.

A data transfer operation by the conventional magnetic disk drive, in conformity with the IEEE 1394 interface standards, will be described with reference to FIG. 1.

Described below is an operation executed in the case where the host requests the magnetic disk drive to read data.

The magnetic disk drive determines whether the page mode is designated in the command (request) supplied from the host (step S101). If the page mode is designated, the magnetic disk drive requests the host to transfer page table data, and receives the page table data from the host (step S102).

The magnetic disk drive obtains “return address” and “return data length” corresponding to data of one page from the received page table data (step S103). Note that the return address indicates destination of the data to be returned, and the return data length indicates length for the data to be returned. The magnetic disk drive sets the return address and return data length to a register of the IEEE 1394 interface (step S104). Thereafter, The magnetic disk drive starts data transfer between the IEEE 1394 interface and a data buffer on a page-by-page basis (step S105).

The magnetic disk drive determines whether the transfer of data of a page corresponding to the return address and return data length set in the register is completed (step S106). If completed, the magnetic disk drive temporarily suspends (stops) the data transfer (step S107), and determines whether there is a remaining page (step S108). If there is a remaining page, the process of the steps S103 to S107 is repeated, thereby transferring data of one page corresponding to the return address and return data length subsequent to the previously obtained return address and return data length. If it is determined that there is no remaining page in the step S108, the process is ended.

On the other hand, if it is determined that the page mode is not designated in step S101, the return address and return data length are set to the register of the IEEE 1394 interface (step S109). Thereafter, data transfer between the IEEE 1394 interface and the data buffer is started (step S110).

The magnetic disk drive determines whether the data transfer corresponding to the return address and return data length set to the register is completed or not (step S11). If it is completed, the data transfer is stopped (step S112) and the process is ended.

As described above, according to the conventional art, in the case where a read command is designated in the page mode, when transfer of data of one page is completed, the data transfer is temporarily suspended, and restarted after the address and data length of data to be transmitted next is obtained from the page table. Therefore, the conventional art has a drawback that the throughput is lowered.

### BRIEF SUMMARY OF THE INVENTION

Accordingly, it is an object of the present invention to provide a data transfer method and data recording apparatus, in which data transfer in the page mode can be executed without lowering the throughput.

According to one aspect of the present invention, there is provided a data recording apparatus comprising: a serial interface which is capable of carrying out data transfer in a page mode for transferring, based on a return address and a return data length specified by a host as a data transfer destination, page data in units of page corresponding to the specified return data length for the specified return address; a page table buffer which stores a page table address defining the return address and return data length for each page data acquired from the host; and a central processing unit which successively supplies to the serial interface, page data in units of page in accordance with the page table address stored in the page table buffer, without interrupting the data transfer in the page mode.

According to another aspect of the present invention, there is provided a data transfer method applied to a data recording apparatus having a serial interface which is capable of carrying out data transfer in a page mode for transferring, based on a return address and a return data length specified by a host as a data transfer destination, page data in units of page corresponding to the specified return data length for the specified return address, the method comprising: storing in a page table buffer a page table address defining the return address and return data length for each page data acquired from the host; and successively supplying to the serial interface, page data in units of page in accordance with the page table address stored in the page table buffer, without interrupting the data transfer in the page mode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a flowchart for explaining a data transfer operation of a conventional magnetic disk drive;

FIG. 2 is a block diagram showing constitution of a magnetic disk drive according to an embodiment of the present invention;

FIG. 3 is a diagram for explaining an interconnection between a host and the magnetic disk drive;

FIG. 4 is a diagram for explaining data constitution of a page table used in a page mode;

FIG. 5 is a diagram for explaining communication procedures executed between the host and the magnetic disk; and

FIG. 6 is a flowchart for explaining a data transfer operation of a magnetic disk drive according to the embodiment.

### DETAILED DESCRIPTION OF THE INVENTION

An embodiment of the present invention will be described with reference to the accompanying drawings.

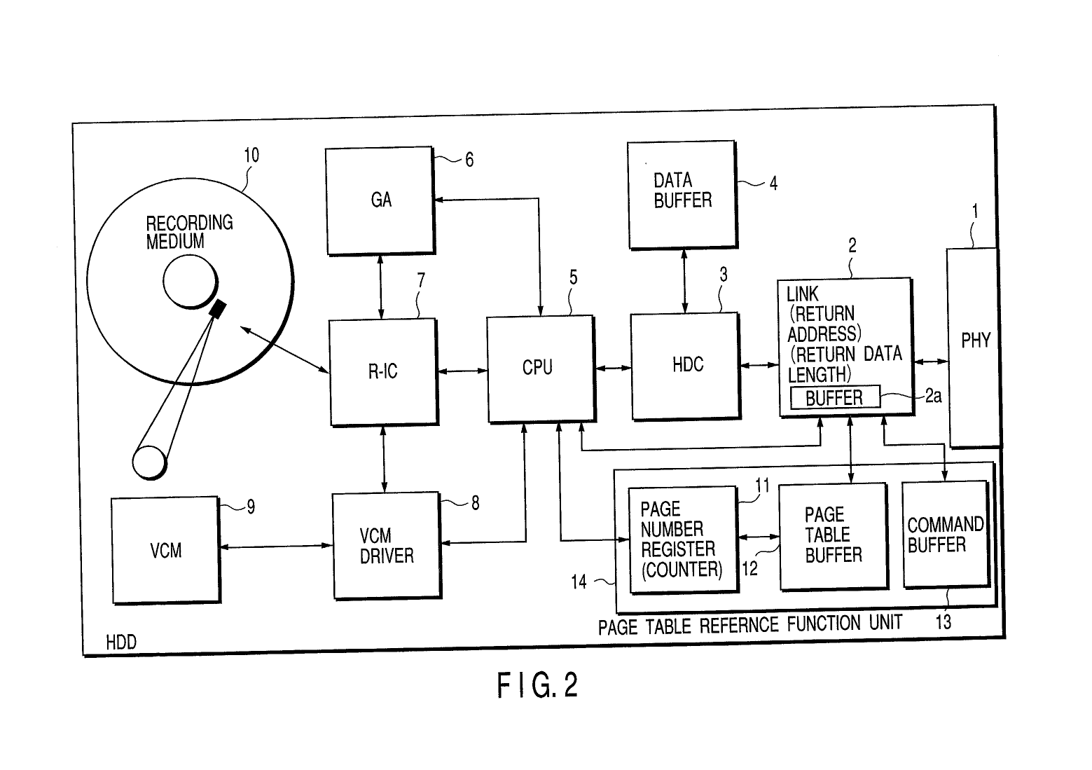

FIG. 2 is a block diagram showing constitution of a magnetic disk drive (hard disk drive: HDD) according to the embodiment.

Referring to FIG. 2, a PHY chip 1 is an IC (integrated circuit) for controlling an IEEE 1394 interface connecting the magnetic disk drive and a host (e.g., a computer main body).

A LINK chip 2, paired with the PHY chip 1, is an IC for controlling communication through the IEEE 1394 interface. The LINK chip 2 includes a buffer (register) 2a. Return addresses and return data lengths stored in a page table buffer 12 are written in units of page in the buffer 2 under control of a CPU 5. The LINK chip 2 transmits and receives data in accordance with the return address and return data length written in the buffer 2a.

An HDC (hard disk controller) 3 is an IC for controlling data transfer between the host and a recording medium 10.

A data buffer 4 is used to temporarily store data, when data is transferred between the host and the recording medium 10. The data buffer 4 is also used to hold cache data and the like.

The CPU (central processing unit) 5 controls the overall internal operation of the magnetic disk drive, such as seek, data transfer and cache processes.

A GA (gate array) 6 generates a sector pulse, etc. necessary for data transfer.

An R-IC 7 is an IC for converting data supplied from the hard disk controller 3 to data to be recorded in the recording medium 10. The R-IC 7 also reads data from the recording medium 10 and converts it to data to be returned to the hard disk controller 3.

A VCM (voice coil motor) driver 8 drives a VCM 9 to move the head to a target position.

The VCM 9 is driven by the VCM driver 8 to move the head to a target position.

The recording medium 10 is a magnetic disk (hard disk) for storing data or the like designated by the host.

A page number register (counter) 11 is used in the page mode to store the number of remaining pages of the contents stored in the page table buffer 12.

The page table buffer 12 is a buffer, used in the page mode, for storing the return address and return data length of each page.

A command buffer 13 is used, when a plurality of command codes are designated by the host, in order to store the command codes.

A page table reference function unit 14 is a portion characteristic of the present invention. It automatically and successively sets (refers to), page by page, return addresses and return data lengths necessary for data transfer from the page table buffer 12 to the register 2a under the control of the CPU 5. With this function, data transfer can be performed without temporary interruption. The page table reference function unit 14 includes the page number register 11, the page table buffer 12 and the command buffer 13. It also includes a part of the CPU 5 and a part of the LINK chip 2, although they are not shown in the drawing.

The LINK chip 2, the HDC 3, the page register 11, the page table buffer 12 and the command buffer 13 may be combined into one unit as a package.

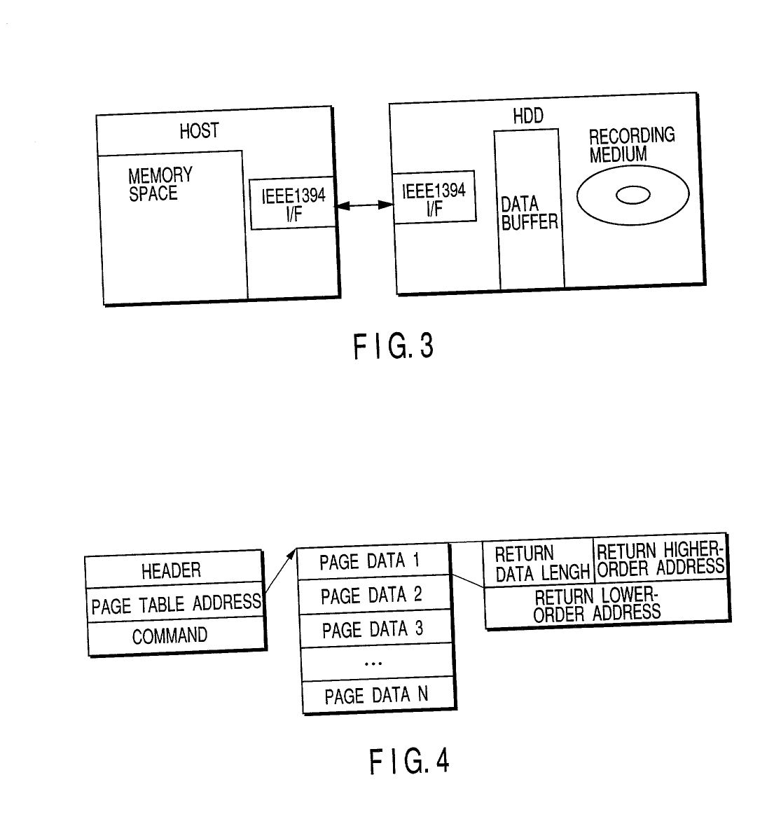

FIG. 3 is a diagram for explaining an interconnection between the host and the magnetic disk drive (HDD).

Each of the host and the magnetic disk drive has an IEEE 1394 interface, so that they can establish communications through an IEEE 1394 cable.

On the host side, data transferred to or from the magnetic disk via the IEEE 1394 interface is stored in a memory space. On the magnetic disk drive side, data transferred to or from the host via the IEEE 1394 interface is read from the recording medium (corresponding to the recording medium 10 shown in FIG. 2) and the read data is temporarily stored in the data buffer (corresponding to the data buffer 4 shown in FIG. 2). The IEEE 1394 interface on the side of the magnetic disk drive is implemented by the PHY chip 1 and the LINK chip 2.

Data constitution of a page table for use in the page mode will be described with reference to FIG. 4.

The host issues a request including a page mode designating command to the magnetic disk drive. The request includes a header (or a top portion), a page table address indicating the position where the page table is stored, and an address indicating the position where the command code is stored.

The page table, including data of a plurality of (an N-number of) pages (or page information), is stored in the portion of the memory indicated by the page table address. The data of each page includes a set of data representing the address to which the data is returned (stored) and the data length (each page data is constituted by 8 bytes: 6 bytes for the address +2 bytes for the data length). With this constitution, the requested data is returned from the magnetic disk drive page by page, and stored in a plurality of regions of the memory space.

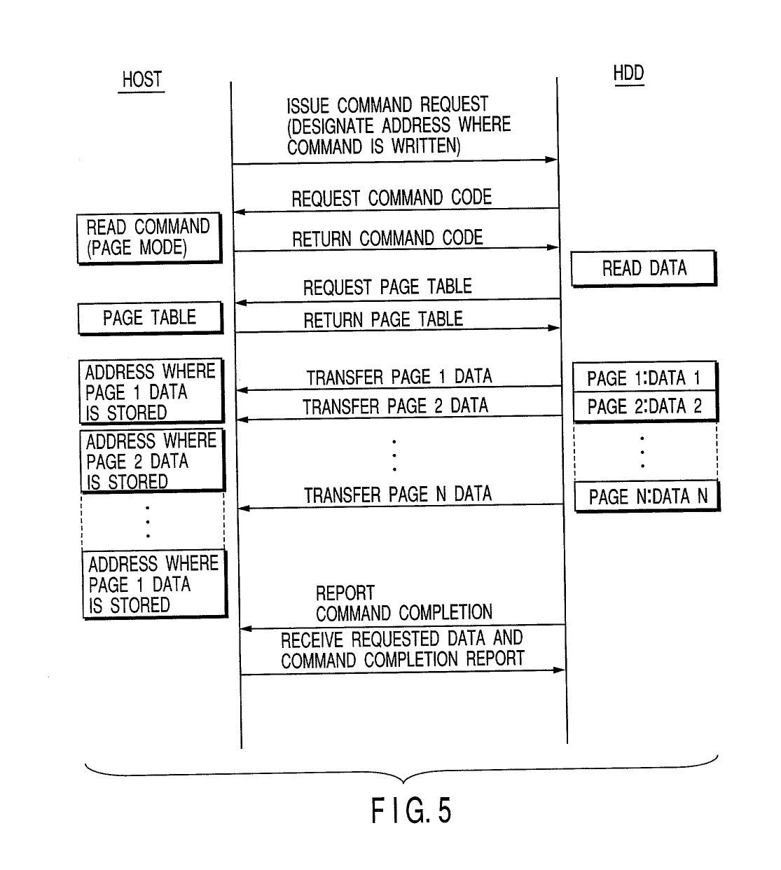

Procedures of communications executed between the host and the magnetic disk will now be described with reference to FIG. 5.

The host issues a request including a page mode designating command to the magnetic disk drive. The command includes a command code address (including information as to whether the page mode is acceptable) and a page table address. The host prestores a command code (in this case, a read command code) and the page table in the memory space thereof.

The magnetic disk drive requests the command code of the address contained in the request, and receives the command code from the host. In this embodiment, it is assumed that the command code includes the information to the effect that the page mode is acceptable.

Since the request designates the page mode, the magnetic disk drive also requests the page table of the page table address contained in the request, and receives the page table from the host. The magnetic disk drive stores the received page table in the page table buffer 12 (shown in FIG. 2). Alternatively, it may be stored in the data buffer 4.

The magnetic disk drive refers to the page table stored in the page table buffer 12 under the control of CPU 5, so that the return addresses and the return data lengths are sequentially set in the buffer 2a page by page and the N-number of pages constituting the data are sequentially transferred to the host in accordance with the set return addresses and return data lengths. The host stores the data of the N-number of pages, successively transferred from the magnetic disk, into predetermined regions of the memory space.

When the data transfer is completed, the magnetic disk drive sends a command completion report to the host. In response to the report, the host sends to the magnetic disk drive a message representing receipt of the requested data and the command completion report.

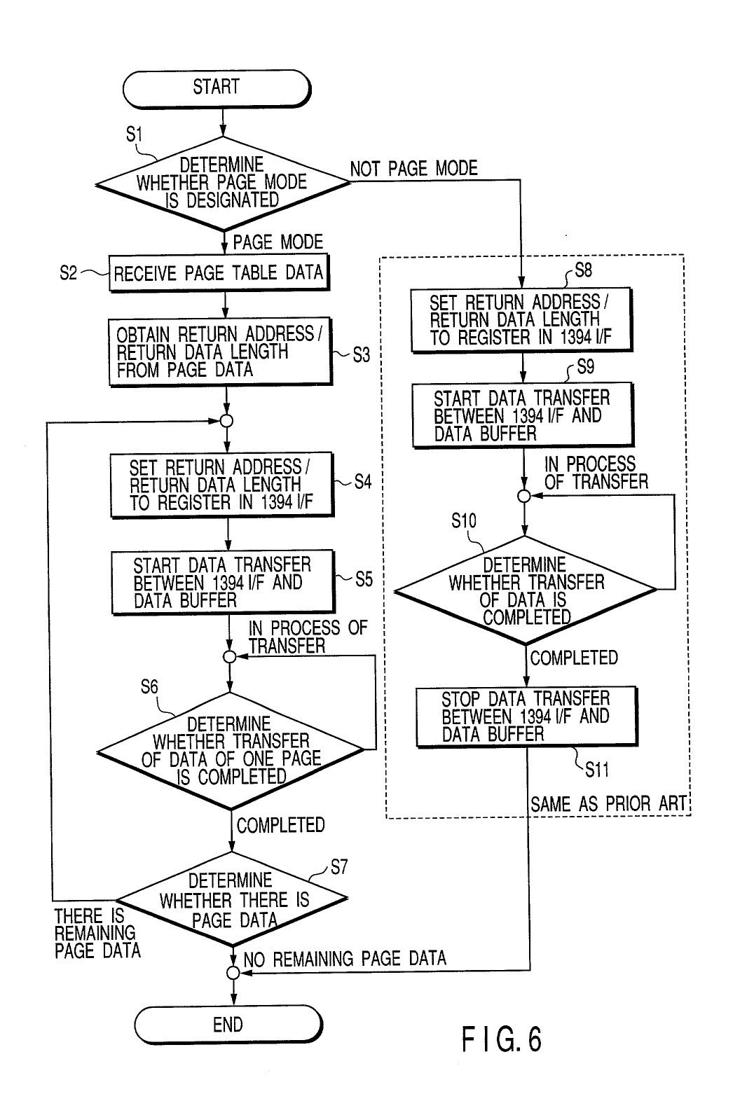

A data transfer operation of the magnetic disk drive according to the embodiment will now be described with reference to FIG. 6.

The IEEE 1394 interface of the magnetic disk drive determines whether the command (request) sent from the host designates the page mode (step Si). If the page mode is designated, the interface requests the page table data from the host, and receives the page table data from the host (step S2).

The received page table is stored in the page table buffer 12. The CPU 5 or the like calculates the number of pages on the basis of the page table data stored in the page table buffer 12. The number of pages is stored in the page number register 11. Thereafter, page-by-page data transfer between the IEEE 1394 interface and the data buffer 4 is started (step S3).

The CPU 5 obtains the return address and the return data length corresponding to the data of one page from the page table data stored in the page table buffer 12 (step S4). It sets the return address and the return data length to the buffer 2a of the LINK chip 2 (step S5). At this time, the CPU 5 decrements by one the number of pages (the count representing the remaining pages) stored in the page number register 11. The CPU 5 reads the data from the recording medium 10 via the R-IC 7, provisionally stores the read data in the data buffer 4, and thereafter sends it to the LINK chip 2.

The LINK chip 2 refers to the return address and the return data length set in the buffer 2a, and sends the data corresponding to the return data length to the PHY chip 1 along with the return address. Then, the PHY chip 1 transfers the data of one page from the magnetic disk drive to the host.

The CPU 5 determines whether the data transfer of one page is completed or not (step S6). If it is completed, the CPU 5 refers to the count value of the page number register 11, so that it can determine whether there is a remaining page (step S7). If there is a remaining page, the process of the steps S4 to S6 is repeated, thereby transferring data of one page corresponding to the return address and return data length subsequent to the previously obtained return address and return data length. If it is determined that there is no remaining page in the step S7, the process is ended.

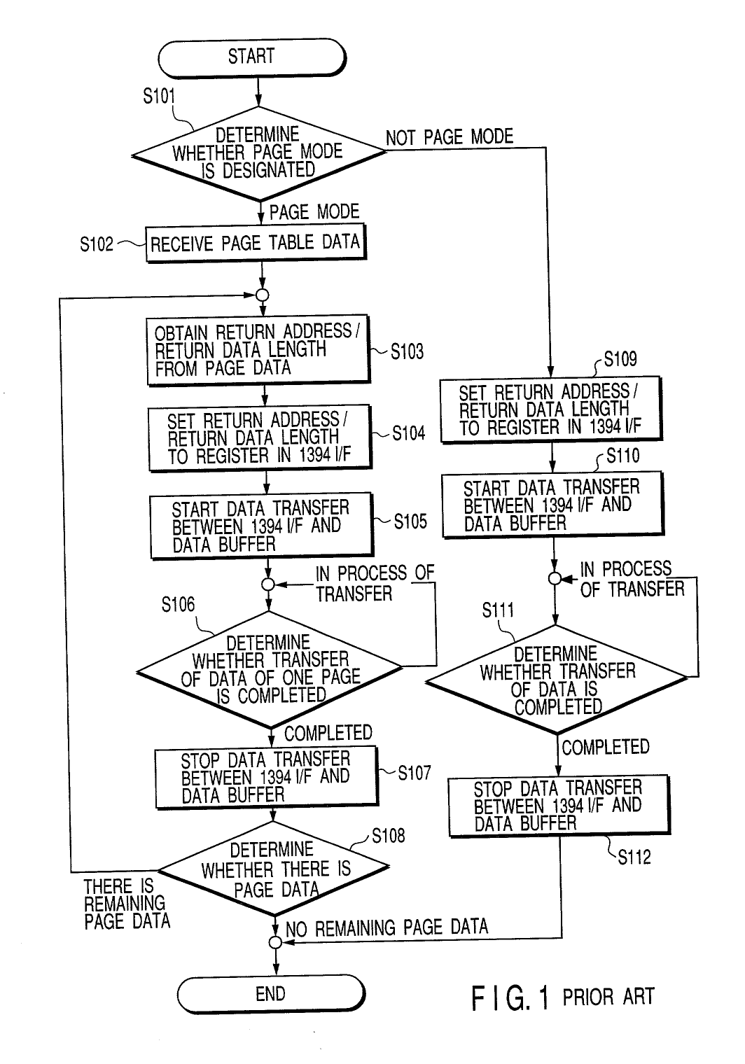

On the other hand, if it is determined that the page mode is not designated in the step Si, the procedures of steps S8 to S11 are executed. Since the procedures are the same as those of the steps S109 to S112 of the prior art (see FIG. 1), the detailed description thereof is omitted.

As described above, according to this embodiment, the return addresses and the return data lengths corresponding to the data of the respective pages are sequentially set in the buffer by the page table reference function. Therefore, the data transfer in the page mode can be performed without reducing the throughput.

The IEEE 1394 interface can be used not only for data transfer but also for command process by designation of memory addresses corresponding to command codes to be processed. In this case also, the command buffer 13 for storing the command table (see FIG. 2), as well as the page table buffer, is provided, so that the magnetic disk drive can perform a function for automatically receiving the next command when the previous command is completed. As a result, the overhead of the command process can be reduced.

The present invention is not limited to the above embodiment, but can be variously modified within the scope of the gist of the invention.

For example, in the above embodiment, the host issues a read command. However, even in the case where the host issues a write command, the same effect can be obtained with the similar hardware constitution.

Further, although the magnetic disk drive is used in the above embodiment, the present invention can be applied to any data storage apparatus, which is capable of storing data, for example, an optical disk drive.

Furthermore, the page table reference function unit 14 of the embodiment described above may be incorporated into an IC for the IEEE 1394 interface, such as the LINK chip. Alternatively, the HDC 3, the LINK chip 2 and the page table reference function unit 14 may be incorporated into a single chip. The single chip may further incorporate the CPU 5.

Still further, the page table may be stored in part of the data buffer, instead of the page table buffer. In this case, the page table can be referred to on the basis of the address of the data buffer where the page table is stored.

As described above, according to the present invention, in the case of using a data recording apparatus, which conforms to serial interface standards capable of transferring data in a page mode, for example, an IEEE 1394 interface, data transfer can be carried out in the page mode without reducing the throughput.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data recording apparatus comprising:
a serial interface which is capable of carrying out data transfer in a page mode for transferring, based on a return address and a return data length specified by a host as a data transfer destination, page data in units of page corresponding to the specified return data length for the specified return address;
a page table buffer which stores a page table address defining the return address and return data length for each page data acquired from the host; and
a central processing unit which successively supplies to the serial interface, page data in units of page in accordance with the page table address stored in the page table buffer, without interrupting the data transfer in the page mode.

2. The apparatus according to claim 1, wherein the serial interface includes an IEEE 1394 interface.

3. The apparatus according to claim 1, wherein:
the central processing unit stores a return address corresponding to page data to be transferred and a return data length to a buffer of the serial interface from page table data stored in the page table buffer, and
the serial interface carries out data transfer of page data, based on the return address and return data length stored in the buffer of the serial interface.

4. The apparatus according to claim 3, wherein the central processing unit sets, when data transfer for data of one page is completed, a return address and a return data length corresponding to data of a next page to the buffer of the serial interface.

5. The apparatus according to claim 1, wherein the central processing unit determines whether data transfer in the page mode is requested and operates in accordance with a result of the determination.

6. The apparatus according to claim 1, further comprising:
a command buffer which stores, when a plurality of command codes are provided, the plurality of command codes.

7. A data transfer method applied to a data recording apparatus having a serial interface which is capable of carrying out data transfer in a page mode for transferring, based on a return address and a return data length specified by a host as a data transfer destination, page data in units of page corresponding to the specified return data length for the specified return address, the method comprising:
storing in a page table buffer a page table address defining the return address and return data length for each page data acquired from the host; and
successively supplying to the serial interface, page data in units of page in accordance with the page table address stored in the page table buffer, without interrupting the data transfer in the page mode.

8. The method according to claim 7, wherein the serial interface includes an IEEE 1394 interface.

9. The method according to claim 7, wherein:
the storing includes storing a return address corresponding to page data to be transferred and a return data length to a buffer of the serial interface from page table data stored in the page table buffer, and
the supplying includes carrying out data transfer of page data, based on the return address and return data length stored in the buffer of the serial interface.

10. The method according to claim 9, wherein the supplying includes setting, when data transfer for data of one page is completed, a return address and a return data length corresponding to data of a next page to the buffer of the serial interface.

11. The method according to claim 7, further comprising:
determining whether data transfer in the page mode is requested and operating in accordance with a result of the determination.

12. The method according to claim 7, further comprising:
storing, when a plurality of command codes are provided, the plurality of command codes.
